(19) United States
(12) Patent Application Publication
(10) Pub. No.: US 2003/0000716 A1
(43) Pub. Date: Jan. 2, 2003

(54) Hand machine tool comprising at least one rotating cutting disk, in particular, a circular saw blade

(76) Inventors: Albrecht Hofmann, Steinbronn (DE); Thomas Schomisch, Leinfelden-Echterdingen (DE)

Correspondence Address: Striker Striker & Stenby, 103 East Neck Road, Huntington, NY, 11743, US

(21) Appl. No.: 10/168,917

(22) PCT Filed: Sep. 7, 2001
(86) PCT No.: PCT/DE01/03445

(30) Foreign Application Priority Data
Dec. 2, 2000 (DE) 100 59 975.3

(51) Int. Cl. B25D 1/00

(52) U.S. Cl. 173/216; 173/29

(57) ABSTRACT

In a power tool with at least one rotating cutting wheel (11), in particular a circular saw blade, having a housing (13) in which a drive motor (14) is accommodated so that its driven shaft (15) extends along the longitudinal housing axis (16), having at least one drive spindle (20) that is supported in rotary fashion in the housing (13) and is aligned at right angles to the driven shaft (15), which drive spindle protrudes laterally from the housing (13) and on the projecting end, supports a cutting wheel mount (24), and having a set of gears for transmitting the rotating motion of the driven shaft (15) to the drive spindle (20), in order to achieve an ergonomically favorable, tilting moment-free operation with the power tool, the housing (13) in the vicinity of the drive spindle (20) and cutting wheel (11), and the drive spindle (20) with the cutting wheel mount (24) are embodied in such a way that the cutting wheel (11) lies in the same plane as the driven shaft (15).

### PRIOR ART

The invention is based on a power tool with at least one rotating cutting wheel, in particular a circular saw blade, of the generic type defined in the preamble to claim 1.

Power tools of this kind are known as so-called right angle grinders. Most often, they have an approximately cylindrical housing with a gear head that contains an angular gear mechanism and a cutting wheel, which is embodied as a grinding wheel and extends lateral to the gear head, parallel to the longitudinal housing axis and is driven by a drive spindle that protrudes from the top of the housing, lateral to the longitudinal housing axis. The gear head is usually connected to a recessed handle that is situated behind the cutting wheel and extends at right angles to a plane extending through the longitudinal housing axis and the drive spindle.

The Wimutec Company of Remscheid produces a universal saw under the type designation ADAMANT, which has the external structural form of the known right angle grinder, but instead of the grinding wheel, is equipped with two saw blades that rotate in opposite directions resting directly against each other. Each saw blade is supported on one of two concentrically disposed drive spindles protruding from the angled head, which are driven by an electric motor in opposite directions by means of an angular gear mechanism.

### ADVANTAGES OF THE INVENTION

The power tool according to the invention has the advantage that the central placement of the at least one cutting wheel in relation to the housing permits an ergonomically favorable, tilting moment-free operation of the power tool by both right- and left-handers.

Advantageous modifications and improvements of the power tool disclosed in claim 1 are possible by means of the steps taken in the remaining claims.

According to an advantageous embodiment of the invention, the capacity of the power tool according to the invention to be operated in a tilting moment-free manner is further improved in that the usual handle is disposed so that it lies in the same plane as the cutting wheel and the handle axis intersects with the axis of the drive shaft.

According to an advantageous embodiment of the invention, a guard is attached to the housing, which covers the rear region of the cutting wheel oriented toward the housing. In this case, the handle is preferably attached to the guard in order, by mounting it close to the cutting wheel, to achieve an optimal guidance of the power tool. A less optimized attachment of the handle to the machine housing, as close as possible behind the guard, can alternatively be provided.

According to a preferred embodiment of the invention, at one end, the housing has an extension arm, which extends parallel to the longitudinal housing axis and has a flat boundary wall that is oriented toward the longitudinal housing axis and extends parallel to this axis, spaced apart from it laterally. The at least one drive spindle is disposed in the frontal region of the extension arm so that it protrudes beyond the flat boundary wall with its projecting end, which supports the mount for the cutting wheel. The degree to which it projects is chosen so that the cutting wheel that is clamped to the cutting wheel mount lies in the same plane as the drive shaft.

The power tool according to the invention can advantageously also be designed for the use of two coaxial cutting wheels rotating in opposite directions. In this instance, according to an advantageous embodiment of the invention, the housing has a second extension arm, which is embodied so as to be mirror symmetrical to the first extension arm in relation to a symmetry plane extending through the driven shaft and supports a rotating second drive spindle, which is aligned with the first drive spindle and can be driven in an opposite direction from it, so that with its projecting end that supports a mount for the second cutting wheel, it protrudes beyond the boundary wall of the extension arm, which is oriented toward the other extension arm. The two cutting wheel mounts on the two drive spindles are set so that the two coaxial cutting wheels that rotate in opposite directions rest against each other axially in such a way that they can still easily rotate in opposite directions.

According to an advantageous embodiment of the invention, the mirror symmetrically embodied second extension arm is detachably connected to the housing so that with a modular design, the same components can be used to produce both a power tool with only one cutting wheel and a power tool with two cutting wheels rotating opposite directions.

According to a preferred embodiment of the invention, the gearing for transmitting the rotating motion of the drive shaft to the drive spindle has a driven gear non-rotatably supported on the driven shaft and in each extension arm, a driving gear whose gear axis is oriented parallel to the drive spindle and whose gear rim meshes with the teeth of the driven gear, and a transmission, which couples the drive spindle to the driving gear. When there are two extension arms, the shafts that support the driving gears in a non-rotatable fashion are aligned with each other or concentrically engage in one another at their ends, where the inner shaft is supported against the outer shaft, which encompasses it, by means of at least one pivot bearing.

According to a preferred embodiment of the invention, the transmission is embodied as a belt drive, which includes a first belt pulley connected to the driving gear, a second belt pulley non-rotatably supported by the drive spindle, and a continuous belt that runs on the belt pulleys. A belt drive of this kind permits a very flat design of the extension arm and therefore a flat design of the housing thus allowing effective operation of this power tool even in tight quarters. In addition, the belt damps torque peaks that emanate from the cutting wheel during operation and therefore reduces wear on the gearing between the driven gear and the driving gear. The belt drive advantageously distributes the required high transmission ratio of the drive shaft to the work spindle over two transmission stages. For example, the speed of the driven shaft of 3000 min⁻¹ can be reduced to the speed of the drive spindle of 300 min⁻¹ with a transmission ratio of 1:5 in the angular gear mechanism between the driven gear and the driving gear and with a transmission ratio of 1:2 in the belt drive. The first belt pulley connected to the driving gear can be disposed on the shaft of the driving gear, in front of or behind this driving gear in terms of the symmetry plane or central plane of the housing. As a result, the diameter of the driven gear on the driven shaft can be modified and e.g. when the first belt pulley is placed in front of the driving gear, a smaller pinion can be used as the driven gear.

In the case in which the power tool is embodied with two cutting wheels rotating in opposite directions, the cutting wheels can be easily removed from and clamped to the cutting wheel mounts if, according to an advantageous embodiment of the invention, each drive spindle is embodied as a hollow shaft with a polygonal, e.g. square, internal cross section, the cutting wheel mount has a flange, which is connected to an internal shaft guided so that it can move axially inside the drive spindle and has axially protruding insertion pins that engage in a form-fitting manner in receiving bores in the cutting wheel, and a compression spring is supported between the flange and the annular end of the hollow drive spindle. The inner shaft advantageously protrudes beyond the outer boundary wall of the extension arm that is oriented away from the cutting wheel mount and in this instance, has an actuating knob for manually sliding the inner shaft counter to the restoring force of the compression spring. If the inner shaft is pulled out, thus causing the compression spring to be compressed, then the insertion pins emerge from the receiving bores in the cutting wheel and the respective cutting wheel can be removed from the flange. When the inner shaft is released, the insertion pins are automatically inserted into the receiving bores in the cutting wheel and the two cutting wheels rest axially against each other.

In an alternative embodiment of the invention, the cutting wheels can also be changed by virtue of the fact that at least one extension arm is supported on the housing in pivoting fashion, the pivot axis being situated coaxial to the shafts of the driving gears. After the extension arm is pivoted away, both of the cutting wheels can be removed frontally from the cutting wheel mounts.

In order to facilitate the installation and removal of the cutting wheels for the power tool that operates with two cutting wheels rotating in opposite directions, the two cutting wheels are connected to each other by means of a form-fitting engagement, which permits the two cutting wheels to easily rotate in relation to each other, and as a structural unit, constitute an easy-to-operate cutting tool, which is inserted, for example, between the above-described cutting wheel mounts disposed between the two extension arms, and is automatically locked in place there.

According to an advantageous embodiment of this cutting tool, the one cutting wheel has tabs bent out from the plane of the wheel and the other cutting wheel has a guide groove, which is concentric to the wheel axis and has an undercut, where the form-fitting engagement is produced by bending the tabs over against the undercut.

In order to bend over the tabs, according to an advantageous embodiment of the invention, bores are provided in the cutting wheel that has the guide groove; these bores open out into the guide groove and are congruent with the tabs when the two cutting wheels are positioned correctly in relation to each other. Through these bores, from the back side of the cutting wheel oriented away from the other cutting wheel, the tabs, which at first protrude at right angles from the cutting wheel into the guide groove, can be bent onto the undercut by means of an accessory tool.

In an alternative embodiment of the cutting tool, the one cutting wheel has tabs which are bent out from the plane of the wheel and the other cutting wheel is comprised of two parts: a ring supporting the cutting means, which ring has a circumferential bevel and a seat incorporated into it, and a hub wheel that rests in the seat and is fastened to the ring. The form-fitting engagement here is produced by bending the tabs over against the bevel.

### DRAWINGS

The invention will be explained in detail in the description below in conjunction with exemplary embodiments shown in the drawings.

FIG. 1 shows a schematic side view of a power tool embodied as a handsaw, with a cutting wheel embodied as a circular saw blade,

FIG. 2 shows a schematic view of the power tool in the direction of the arrow II in FIG. 1,

FIG. 3 shows a schematic view of the power tool in the direction of the arrow III in FIG. 2,

FIG. 4 shows a schematic detail of a section along the line IV-IV in FIG. 1,

FIG. 5 shows a schematic detail of a longitudinal section through a power tool embodied as a handsaw, with two cutting wheels embodied as circular saw blades that rotate in opposite directions,

FIG. 6 is a depiction equivalent to that in FIG. 5 of a modified version of the power tool according to FIG. 5,

FIG. 7 is a schematic side view of a power tool with two cutting wheels that rotate in opposite directions, in a cutting wheel replacement position,

FIG. 8 is a schematic top view of the one cutting wheel of a cutting tool, which is comprised of two cutting wheels that rotate in opposite directions and is intended for use in the power tool according to FIG. 6,

FIG. 9 is a schematic top view of the other cutting wheel of the cutting tool,

FIG. 10 shows a schematic section through the cutting tool, which is comprised of the two cutting wheels according to FIGS. 8 and 9, along the cutting line X-X in FIG. 8,

FIG. 11 is a schematic cross section through a cutting tool comprised of two cutting wheels according to another exemplary embodiment.

### DESCRIPTION OF THE EXEMPLARY EMBODIMENTS

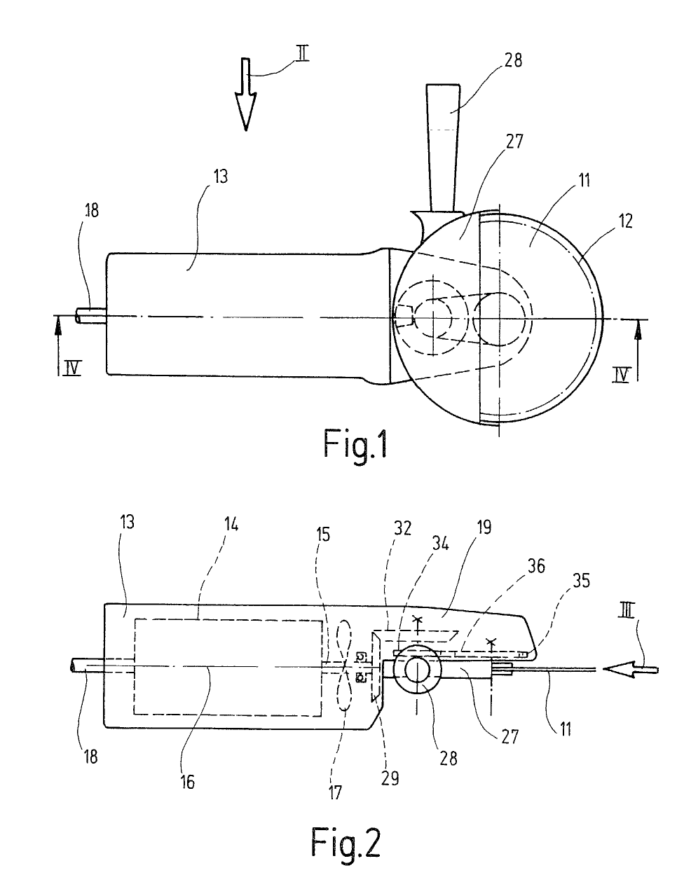

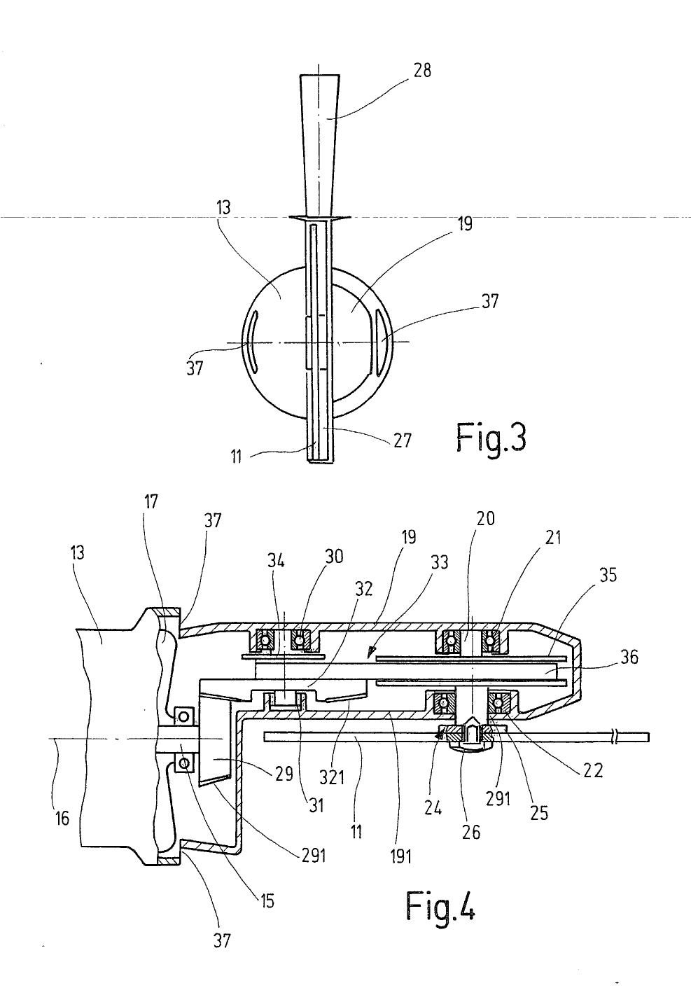

The power tool, various views of which are shown in FIGS. 1 to 3 and a sectional view of which is shown in FIG. 4, is embodied as a manual circular saw with a circular saw blade 11, whose serration is symbolized in FIG. 1 by the partial circle 12 of saw teeth indicated with a dot-and-dash line. If the power tool is to be used as a disc grinder, then the saw blade 11 is replaced by a conventionally designed grinding blade. Thus in the following, the general term cutting wheel 11 is used for both the saw blade and the grinding blade.

The power tool has a housing 13, in which an electric drive motor 14, which is depicted with dot-and-dash lines in FIG. 2, is accommodated in such a way that its driven shaft 15 extends coaxial to the longitudinal housing axis 16 or extends parallel to and spaced slightly apart from this longitudinal housing axis 16. A ventilating fan 17 supported on the driven shaft 15 and an electric connecting cable 18, which both belong to the drive motor 14, are also indicated. At one end, the housing 13 has an extension arm 19, which extends parallel to the longitudinal housing axis 16 and has a flat boundary wall 191 that is oriented toward the longitudinal housing axis 16 and extends parallel to this axis, spaced laterally apart from it. Close to the front end of the extension arm 19, a drive spindle 20 is supported in rotary fashion by means of two radial bearings 21, 22, which are embodied as ball bearings in this instance (FIG. 4). The drive spindle 20 is aligned at right angles to the driven shaft 15 and passes through the boundary wall 191 by means of an opening 23 in the boundary wall 191. At the projecting end of the drive spindle 20, a cutting wheel mount 24 is provided, which in the exemplary embodiment is embodied as a contact flange 25 against which the cutting wheel 11 is centrally clamped by means of a locking screw 26. The projecting end of the drive spindle 20 with the cutting wheel mount 24 is embodied so that the cutting wheel 11 lies in the same plane as the driven shaft 15. As shown in FIGS. 1 to 3, a guard 27 is fastened to the housing 13, in fact on the extension arm 19 of the housing, so that it covers the rear region of the cutting wheel oriented toward the housing 13. In order to achieve an ergonomically favorable, tilting moment-free operation of the power tool, a handle 28 is fastened to the guard 27 so that the handle lies in the same plane as the cutting wheel 11 and a projection of it intersects the axis of the driven shaft 15. The handle 28 can also be fastened to the housing 13, in which case it is aligned in the same manner.

In order to drive the cutting wheel 11, a set of gears is provided between the driven shaft 15 and the drive spindle 20, which set of gears has a driven gear 29 non-rotatably supported on the driven shaft 15, a driving gear 32, which is rotatably supported in the extension arm 19 by means of a radial bearing 30 embodied as a ball bearing and by means of a radial bearing 31 embodied as a needle bearing, and a transmission 33, which is coupled to the drive spindle 20 and is disposed in the extension arm 19. The driving gear 32, which is preferably embodied as a crown wheel and is non-rotatably supported on a shaft 38, has a gear rim 321 that meshes with the gearing 291 of the driven gear 29, which is embodied as a pinion or bevel gear. The drive spindle 20 and the shaft 38 of the driving gear 32 are aligned parallel to each other. The transmission 33 in this instance is embodied as a belt drive, which includes a first belt pulley 34 affixed to the driving gear 32, a second belt pulley 35 non-rotatably supported on the drive spindle 20, and a continuous belt 36 running around the belt pulleys 34, 35. The first belt pulley 34 is non-rotatably supported on the shaft 38 of the driving gear 32, between the two radial bearings 30, 31. In the exemplary embodiment of FIG. 4, the first belt pulley 34 is placed against the rear side of the driving gear 32 oriented away from the gear rim 321. As alternatively indicated in FIG. 2, the first belt pulley 34 can also be disposed in front of the driving gear 32 so that the gear rim 321 of the driving gear 32 is oriented toward the first belt pulley 34. In this instance, the diameter of the driven gear 29 supported on the driven shaft 15 can be smaller. The speed of the drive shaft 15 is reduced to the desired speed of the cutting wheel 11 in two transmission stages by means of the angular gear mechanism constituted by the driven gear 29 and the driving gear 32 and the transmission 33 constituted by the belt drive.

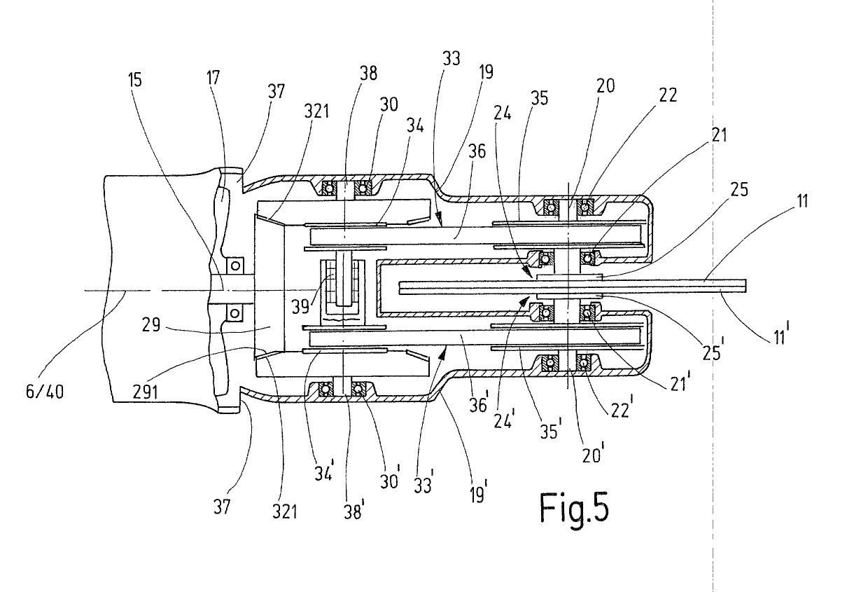

In the exemplary embodiments of the power tool according to FIGS. 5 to 7, the power tool is embodied as a manual circular saw with circular saw blades that rotate in opposite directions. Here, too, the saw blades can be replaced by grinding wheels in order to use the power tool as a disc grinder. Therefore the synonym “cutting wheels” is once again used for the saw blades. The two coaxially disposed cutting wheels 11, 11′ rest with their blade planes against each other so that they can easily be rotated in opposite directions. The cutting wheels 11, 11′ are once again disposed so that with their disc planes resting against each other, they lie in the plane running through the drive shaft 16, which plane constitutes the symmetry plane 40 of the housing 13 in the exemplary embodiment.

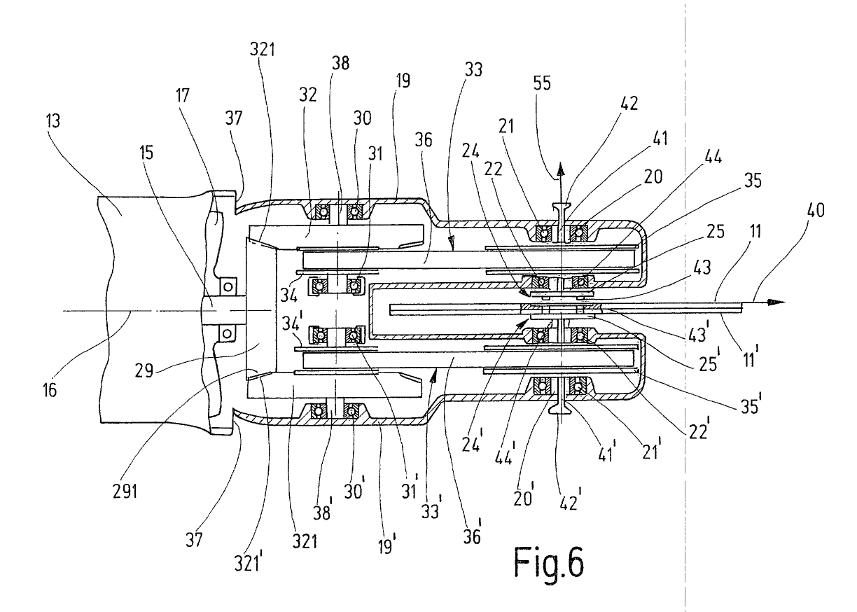

As described above, the cutting wheel 11 is clamped to the drive spindle 20, which is supported in the extension arm of the housing 13 and is driven in the above-described manner by the driven shaft 15. The cutting wheel 11′ is clamped to a drive spindle 20′ aligned coaxially to the drive spindle 20. The drive train for the drive spindle 20′ is identical to the drive train for the drive spindle 20 and is contained in a second extension arm 19′, which is disposed on the housing 13 mirror-symmetrically to the first extension arm 19 so that the two boundary walls 191, 191′ of the two extension arms 19, 19′ are oriented toward each other and are spaced the same lateral distance apart from the symmetry plane 40 of the housing 13. All explanations relating to the cutting wheel 11 and its drive train also apply to the cutting wheel 11′ and its drive train; in the drawings, similar components are provided with the same reference numerals accompanied by a prime symbol. The shafts 38, 38′ supporting the driving gears 32, 32′ are aligned with each other and are each supported in a radial bearing 30, 31 and 30′, 31′ (FIG. 6). In the exemplary embodiment of FIG. 5, the shaft 38′ is embodied as a hollow shaft into which the shaft 38 protrudes. The shaft 38 is supported inside the hollow shaft 38′ by a ball bearing 39. The two driving gears 32, 32′, whose gear rims 321, 321′ mesh with the gearing 291 of the driven gear 29, are driven in opposite directions and transmit their rotating motion to the drive spindles 20, 20′ via the belt drives, which constitute the transmissions 33, 33′ and are comprised of belt pulleys 34, 35 and 34′, 35′ and continuous belts 36, 36′.

In a modification of the power tool, the second extension arm 19′ can be designed so that it can be completely removed from the housing 13. If the extension arm 19′ is removed, then the power tool that is designed to operate with two cutting wheels 11, 11′ can be used as a manual circular saw with a saw blade or can be operated as a right angle grinder or disc grinder with a grinding blade, as described in conjunction with FIGS. 1 to 4.

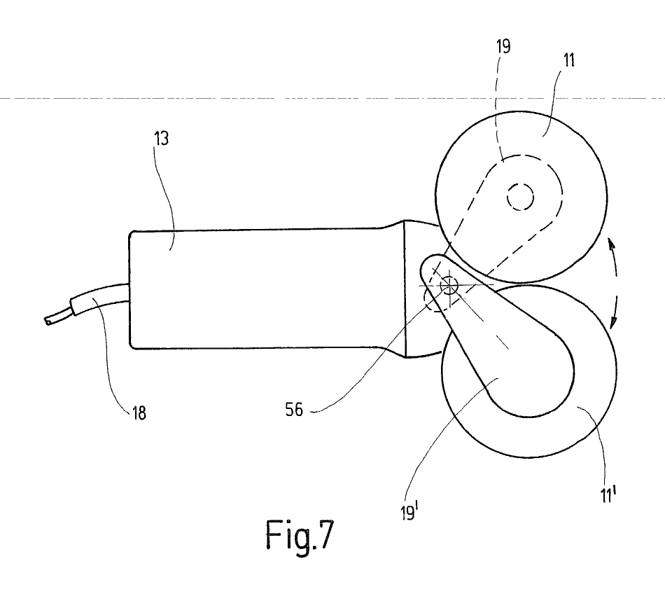

In another embodiment of the power tool that operates with two cutting wheels 11, 11′ rotating in opposite directions, for a simpler changing of the saw blades 11, 11′, at least one of the two extension arms 19, 19′ is fastened to the housing 13 in pivoting fashion, where the pivot axis 56 is aligned with the axes of the two shafts 38, 38′ supporting the driving gears 38, 38′ and the belt pulleys 34, 34′. In the power tool shown in a schematic side view in FIG. 7, both of the extension arms 19, 19′ are embodied as pivoting. In the operating position, both extension arms 19, 19′ are aligned as shown in FIG. 5 and are locked in place on the housing 13. In order to change the cutting wheels 11, 11′, the locking mechanisms of the two extension arms 19, 19′ are released and the two extension arms 19, 19′ are pivoted in the manner shown in FIG. 7. The cutting wheel 11, 11′ on each extension arm 19, 19′ is now freely accessible and can be detached from the cutting wheel mount 24.

The exemplary embodiment of the power tool shown in FIG. 6, with two cutting wheels 11, 11′ rotating in opposite directions, has a modification of the cutting wheel mounts 24, 24′, which permits the cutting wheels 11, 11′ to be easily replaced when the extension arms 19, 19′ are fixed in place. The two cutting wheel mounts 24 are embodied identically so that only the cutting wheel mount 24 is described here, but this description applies equally to the cutting wheel mount 24′ for the cutting wheel 11′. The drive spindle 20 is embodied as a hollow shaft with a polygonal, e.g. square, internal cross section. The cutting wheel mount 24, which is once again embodied as a flange 25, is connected to an internal shaft 41 guided so that it can move axially inside the hollow drive spindle 20; the flange 25 can be of a unit with the internal shaft 41. The internal shaft 41 protrudes beyond the outer boundary wall 192 of the extension arm 19 and at its free end, has a grasping knob 42 for manually sliding the internal shaft 41. On its front side oriented away from the internal shaft 41, the flange 25 has a number of axially protruding insertion pins 43 that engage in a form-fitting manner in correspondingly embodied receiving bores in the cutting wheel 11. A compression spring 44 is supported between the flange 25 and the annular end of the drive spindle 20, which spring slides the insertion pins 43 into the receiving bores in the cutting wheel 11 and holds them there with frictional engagement during operation of the power tool. FIG. 6 shows the cutting wheel mount 24 for the cutting wheel 11′ in the operating position and the cutting wheel mount 24 for the cutting wheel 11 in the released position. If the inner shaft 41 is pulled upward in the direction of arrow 55, counter to the restoring of the compression spring 44, then the insertion pins 43 on the flange 25 are pulled out from the receiving bores in the cutting wheel 11 and the cutting wheel 11 can be removed and replaced with another cutting wheel. This new cutting wheel 11 in turn is positioned so that the insertion pins 43 are aligned with the receiving bores in the cutting wheel 11 so that when the inner shaft 41 is released, the insertion pins 43 are inserted into the receiving bores again and the flange 25 presses the cutting wheel 11 against the cutting wheel 11′. The compressive force is of such a magnitude that the two cutting wheels 11, 11′ can still be easily rotated in opposite directions.

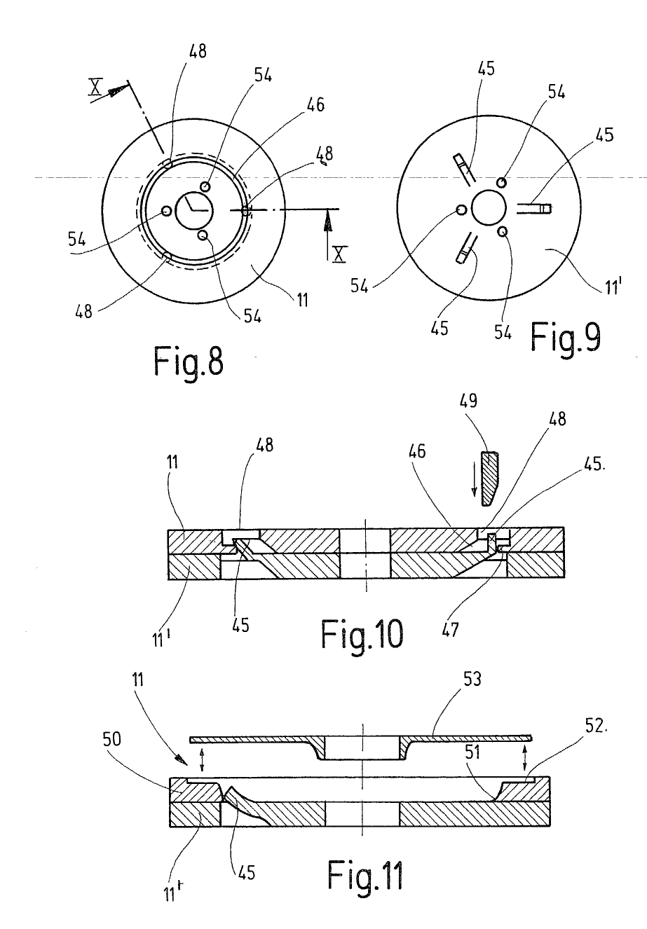

FIGS. 8-10 on the one hand and FIG. 11 on the other show respective exemplary embodiments of the cutting wheels 11, 11′, which are intended for use in the power tool according to FIG. 6. For easy handling during the changing of the cutting wheels 11, 11′, the two cutting wheels 11, 11′ are combined into one cutting tool, which is replaced as a compete unit. The two cutting wheels 11, 11′ are connected to each other by means of a form-fitting engagement, which permits the two cutting wheels 11, 11′ to easily rotate in opposite directions.

In the exemplary embodiment of the cutting tool according to FIGS. 8-10, the one cutting wheel 11′ has three tabs 45 bent out from the plane of the wheel and the other cutting wheel 11 has a guide groove 46, which is concentric to the axis of the cutting wheel 11 and has an undercut 47. The cutting wheel 11 is shown in a top view in FIG. 8 and the cutting wheel 11′ is shown in a top view in FIG. 9; each of these Figs. shows the respective side of the cutting wheel 11, 11′ that rests against the other. The depiction of the saw teeth that are customary on a saw blade has been omitted from FIGS. 8-10. The three tabs 45 of the cutting wheel 11′ are disposed offset from one another by the same circumferential angle. Naturally, more tabs 45 can be provided, but it is mandatory that there be at least two tabs 45. As long as the cutting wheel 11′ is still separate, the tabs 45 protrude at right angles from the plane of the cutting wheel and can be inserted into the guide groove 46 when the other cutting wheel 11 is set in place. In order to then produce the form-fitting engagement, the cutting wheel 11 has bores 48, which open out into the guide groove 46 and are situated so that they lie in the vicinity of the tabs 45 when the two cutting wheels 11, 11′ are correspondingly positioned in relation to each other. If the two cutting wheels 11, 11′ are correctly placed one on top of the other, then an external accessory tool 49 can be used to bend the tabs 45 through the bores 48 in the cutting wheel 11, thus producing the form-fitting engagement that permanently secures the two cutting wheels 11, 11′ to each other. The amount of bending and the tolerances should be chosen so that after being attached to each other, the two cutting wheels 11, 11′ can still be easily rotated in opposite directions. In FIG. 10, the right half of the drawing shows a tab 45 at a point when the form-fitting engagement with the cutting wheel 11 has not yet been produced. With the tab 45 shown in the left half of the drawing, the form-fitting engagement has been executed and the tab 45 overlaps the undercut 47.

In the exemplary embodiment of the cutting tool according to FIG. 11, the cutting wheel 11′ once again has tabs which are bent out from the plane of the wheel. The other cutting wheel 11 is embodied as composed of two parts. It is comprised of a ring 50 that supports the saw teeth or the grinding means (not shown), which ring, on its annular side oriented toward the other cutting wheel 11′, has a continuous circumferential bevel 51 along the inner edge, and a seat 52 embodied on its annular side oriented away from the cutting wheel 11′, as well as a hub wheel 53 that rests in the seat 52 and is fastened to the ring 50. The form-fitting engagement of the two cutting wheels 11, 11′ is once again produced by bending the tabs 45 over against the bevel 51 when the cutting wheels 11, 11′ are resting against each other; the bending and the tolerances are chosen so that after being attached to each other, the two cutting wheels 11, 11′ can still be easily rotated in opposite directions. Then, the hub wheel 53 is inserted into the seat 52 and affixed to the ring 50 by means of a welding process, or by means of glue, rivets, pins, or screws.

FIG. 8 and FIG. 9 also show the receiving bores 54 provided in the cutting wheels 11, 11′, which bores are used to achieve the above-described clamping of the cutting tool onto the cutting wheel mounts 24, 24′ of the power tool according to FIG. 6. These receiving bores 54 do not appear in FIGS. 10 and 11 as a result of the sectional paths chosen.

1. A power tool with at least one rotating cutting wheel (11, 11′), in particular a circular saw blade, having a housing (13) in which a drive motor (14) is accommodated so that its driven shaft (15) extends along the longitudinal housing axis (16), having at least one drive spindle (20, 20′) that is supported in rotary fashion in the housing (13) and is aligned at right angles to the driven shaft (15), which drive spindle protrudes laterally from the housing (13) and on the projecting end, supports a cutting wheel mount (24, 24′), and having a set of gears for transmitting the rotating motion of the driven shaft (15) to the at least one drive spindle (20, 20′), characterized in that the housing (13) in the vicinity of the drive spindle (20, 20′) and cutting wheel (11, 11′), and the at least one drive spindle (20, 20′) with the cutting wheel mount (24, 24′) are embodied in such a way that the at least one cutting wheel (20, 20′) lies approximately in the same plane as the driven shaft (15).

2. The power tool according to claim 1, characterized in that at one end, the housing (13) has an extension arm (19), which extends parallel to the longitudinal housing axis (16) and has a flat boundary wall (191), which extends parallel to the longitudinal housing axis (16) and is spaced apart laterally from this longitudinal housing axis (16), and that the drive spindle (20) is disposed in the extension arm (19) so that it protrudes beyond the flat boundary wall (191) with its projecting end, which supports the cutting wheel mount (24)

3. The power tool according to claim 2, characterized in that the housing (13) has a second extension arm (19′), which is embodied so as to be mirror symmetrical to the first extension arm (19), where a symmetry plane (40) extends through the driven shaft (15), that a second drive spindle (20′), which is aligned with the first drive spindle (20) and can be driven in an opposite direction from it, is supported in rotary fashion in the second extension arm (19′) so that with its projecting end that supports a second cutting wheel mount (24′), this second drive spindle (20′) protrudes beyond the boundary wall (191′) of the second extension arm (19′), and that the cutting wheel mounts (24, 24′) are set so that the two coaxial cutting wheels (11, 11′) that rotate in opposite directions rest against each other axially.

4. The power tool according to claim 2 or 3, characterized in that the set of gears has a driven gear (29) non-rotatably supported on the driven shaft (15) and preferably embodied as a pinion, has a driving gear (32, 32′) disposed in each extension arm (19, 19′), preferably embodied as a crown wheel, aligned with its gear axis parallel to the drive spindle (20, 20′), with a gear rim (321, 321′) that meshes with the gearing (291) of the driven gear (29), and has a transmission (33, 33′) that couples the drive spindle (20, 20′) to the driving gear (32, 32′).

5. The power tool according to claim 4, characterized in that the transmission (33, 33′) is embodied as a belt drive, which includes a first belt pulley (34, 34′) affixed to the driving gear (32, 32′), a second belt pulley (35, 35′) non-rotatably supported on the drive spindle (20, 20′), and a continuous belt (36, 36′) running around the belt pulleys (34, 35; 34′, 35′).

6. The power tool according to one of claims 3 to 5, characterized in that each drive spindle (20, 20′) is embodied as a hollow shaft with a polygonal, e.g. square, internal cross section, that the cutting wheel mount (24, 24′) has a flange (25, 25′), which is preferably connected in one piece to an internal shaft (41, 41′) axially guided inside the drive spindle (20, 20′) and has axially protruding insertion pins (43, 43′) that engage in a form-fitting manner in receiving bores (54) in the cutting wheel (11, 11′), and that a compression spring (44, 44′) is supported between the flange (25, 25′) and the annular end of the hollow drive spindle (20, 20′).

7. The power tool according to claim 4 or 5, characterized in that at least one of the two extension arms (19, 19′) on the housing (13) is embodied so that it can pivot around a pivoting axis (56) coaxial to the gear axes of the driving gears (32, 32′).

8. A cutting tool with two cutting wheels (11, 11′), which rotate in opposite directions and are in particular embodied as circular saw blades, particular intended for use in a power tool according to one of claims 3 to 6, characterized in that the two cutting wheels (11, 11′) are connected to each other by means of a form-fitting engagement that permits them to easily rotate in relation to each other.

9. The cutting tool according to claim 8, characterized in that the one cutting wheel (11′) has tabs (45) bent out from the plane of the wheel and the other cutting wheel (1) has a guide groove (46), which is concentric to the wheel axis and has an undercut (47), and that the form-fitting engagement is produced by bending the tabs (45) over against the undercut (47).

10. The cutting tool according to claim 8, characterized in that the one cutting wheel (11′) has tabs (45) bent out from the plane of the wheel, that the other cutting wheel (11) is comprised of a ring (50) that supports the cutting means, preferably saw teeth, which ring has a circumferential bevel (51) along the inner edge on its annular side oriented toward the other cutting wheel (11′), a seat (52) embodied on its annular side oriented away from the other cutting wheel (11), and a hub wheel (53) that rests in the seat (52) and is fastened to the ring (50), and that the form-fitting engagement is produced by bending the tabs (45) over against the bevel (51).
